(19) United States
(12) Patent Application Publication
(10) Pub. No.: US 2025/0063594 A1
(43) Pub. Date: Feb. 20, 2025

(54) PEER-TO-PEER COMMUNICATION IN WIRELESS NETWORKS

(71) Applicant: Samsung Electronics Co., Ltd., Suwon-si (KR)

(72) Inventors: Rubayet Shafin, Frisco, TX (US); Boon Loong Ng, Plano, TX (US); Vishnu Vardhan Ratnam, Plano, TX (US); Peshal Nayak, Plano, TX (US); Yue Qi, Plano, TX (US); Elliot Jen, Taipei (TW)

(21) Appl. No.: 18/792,493

(22) Filed: Aug. 1, 2024

Related U.S. Application Data
(60) Provisional application No. 63/533,573, filed on Aug. 18, 2023.

(51) Int. Cl. H04W 74/08; H04W 76/14

(52) U.S. Cl. CPC H04W 74/08; H04W 76/14

(57) ABSTRACT

A first station (STA) in a wireless network is provided. The first STA establishes a peer-to-peer (P2P) link with a second STA. The first STA transmits, to an access point (AP), a first frame that requests the AP to assist in protecting a P2P communication between the first STA and the second STA. In response to the first frame, the first STA receives, from the AP, a second frame that indicates assistance that the AP is able to provide in response to the first frame. Then the first STA communicates with the second STA based on the assistance provided from the AP.

### CROSS-REFERENCE TO RELATED APPLICATIONS

This application claims the benefit of priority from U.S. Provisional Application No. 63/533,573, entitled “METHOD AND APPARATUS FOR P2P COMMUNICATION ASSISTANCE,” filed Aug. 18, 2023, which is incorporated herein by reference in its entirety.

### TECHNICAL FIELD

This disclosure relates generally to a wireless communication system, and more particularly to, for example, but not limited to, peer-to-peer (P2P) communications in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the disclosure provides a first station (STA) in a wireless network. The first STA comprises a memory and a processor coupled to the memory. The processor is configured to cause establishing a peer-to-peer (P2P) link with a second STA. The processor is configured to cause transmitting, to an access point (AP), a first frame that requests the AP to assist in protecting a P2P communication between the first STA and the second STA. The processor is configured to cause receiving, from the AP, a second frame that indicates assistance that the AP is able to provide in response to the first frame. The processor is configured to cause communicating with the second STA based on the assistance provided from the AP.

In some embodiments, the assistance is associated with reduction of interference to the P2P link from a basic service set (BSS) corresponding to the AP.

In some embodiments, the assistance is associated with channel access opportunity by the first STA or the second STA.

In some embodiments, the first STA is associated with the AP and the second STA is not associated with the AP.

In some embodiments, the first STA is not associated with the AP and the second STA is associated with the AP.

In some embodiments, the first STA is an owner of a P2P group that includes the first STA and the second STA.

In some embodiments, at least one of the first STA or the second STA is within the BSS.

An aspect of the disclosure provides an access point (AP) in a wireless network. The AP comprises a memory and a processor coupled to the memory. The processor is configured to cause receiving, from a first STA, a first frame that requests the AP to assist in protecting a peer-to-peer (P2P) communication with a second STA over a P2P link established between the first STA and the second STA. The processor is configured to cause determining assistance to provide the first STA based on the first frame. The processor is configured to cause transmitting, to the first STA, a second frame that indicates the assistance that the AP is able to provide.

In some embodiments, the assistance is associated with reduction of interference to the P2P link from a basic service set (BSS) corresponding to the AP.

In some embodiments, the assistance is associated with channel access opportunity by the first STA or the second STA.

In some embodiments, the first STA is associated with the AP and the second STA is not associated with the AP.

In some embodiments, the first STA is not associated with the AP and the second STA is associated with the AP.

In some embodiments, the first STA is an owner of a P2P group that includes the first STA and the second STA.

In some embodiments, at least one of the first STA or the second STA is within the BSS.

An aspect of the disclosure provides a method performed by a first station (STA) in a wireless network. The method comprises establishing a peer-to-peer (P2P) link with a second STA, transmitting, to an access point (AP), a first frame that requests the AP to assist in protecting a P2P communication between the first STA and the second STA, receiving, from the AP, a second frame that indicates assistance that the AP is able to provide in response to the first frame, and communicating with the second STA based on the assistance provided from the AP.

In some embodiments, the assistance is associated with reduction of interference to the P2P link from a basic service set (BSS) of the AP.

In some embodiments, the assistance is associated with channel access opportunity by the first STA or the second STA.

In some embodiments, the first STA is associated with the AP and the second STA is not associated with the AP.

In some embodiments, the first STA is not associated with the AP and the second STA is associated with the AP.

In some embodiments, the first STA is an owner of a P2P group that includes the first STA and the second STA.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example network in accordance with an embodiment.

FIG. 5 shows an example of a P2P link and infrastructure network in accordance with an embodiment.

FIG. 6 shows another example of a P2P link and infrastructure network in accordance with an embodiment.

FIG. 7 shows an example scenario of a P2P network and infrastructure network in accordance with an embodiment.

FIG. 8 shows an example P2P assistance in accordance with an embodiment.

FIG. 9 shows an example process 900 of coexistence between the P2P network and the infrastructure network in accordance with an embodiment.

FIG. 10 shows another example process 1000 of coexistence between the P2P network and the infrastructure network in accordance with an embodiment.

FIG. 11 shows another example of coexistence between the P2P network and the infrastructure network in accordance with an embodiment.

FIG. 12 shows another example of coexistence between the P2P network and the infrastructure network in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

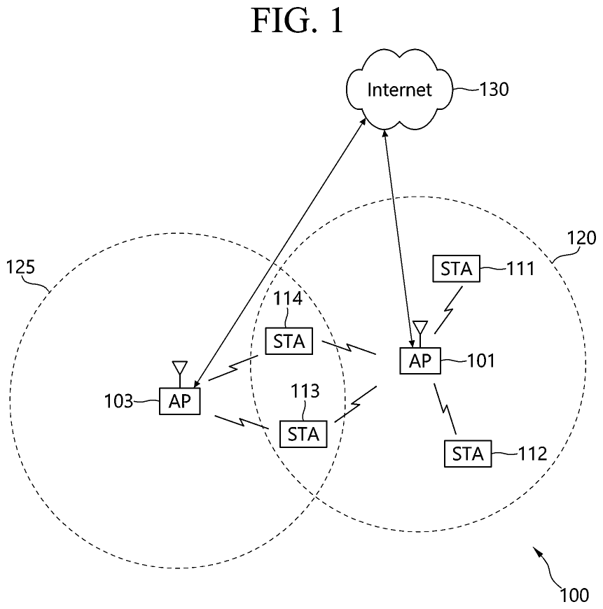

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

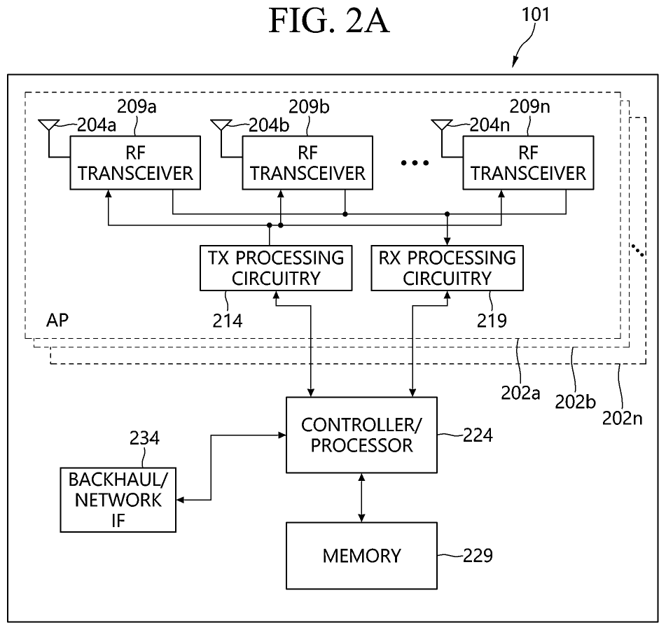

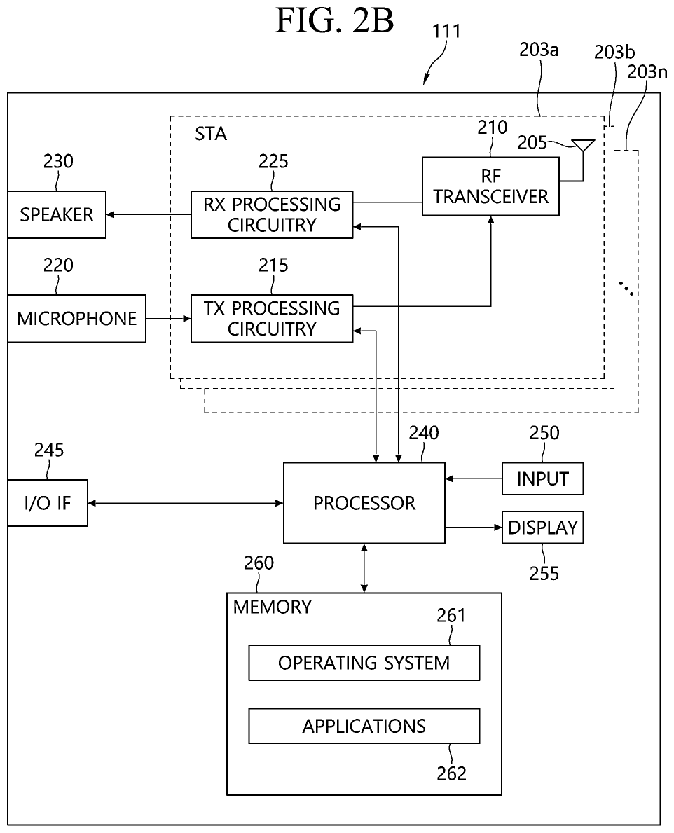

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

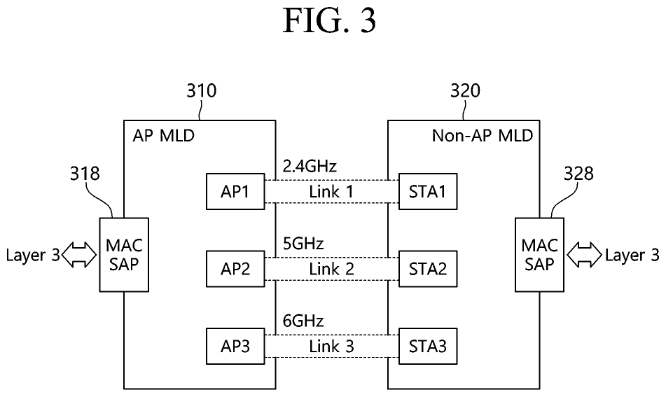

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.1, “Wireless LAN Medium Access Control (MAC) and Physical Layer (PHY) Specifications.”

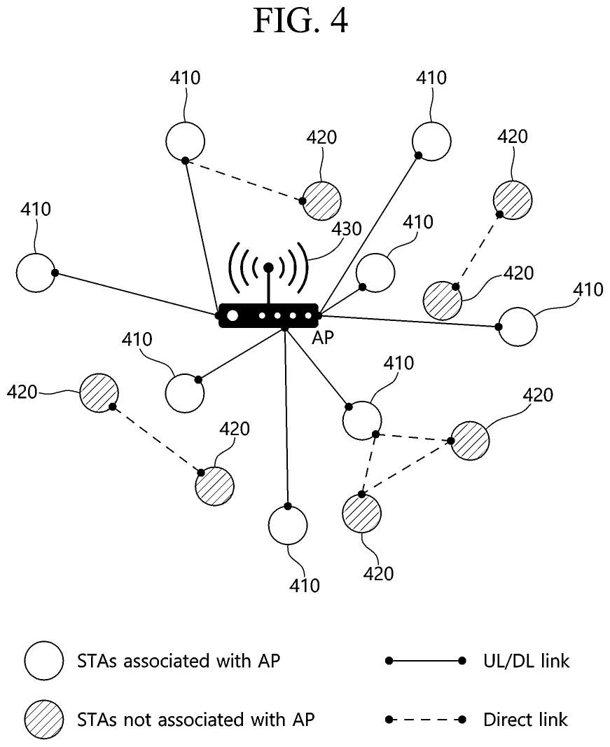

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 are non-AP stations associated with AP 430, and a plurality of STAs 420 are non-AP stations which are not associated with AP 430. Additionally, solid lines between stations represent uplink or downlink with AP 430, while the dashed lines between stations represent a direct link between STAs.

Next generation WLAN system needs to provide improved support for low-latency applications. Today, it is not uncommon to observe numerous devices operating on the same network. Many of these devices may have a tolerance for latency, but still compete with the devices running low-latency applications for the same time and frequency resources. In some cases, the AP as a network controller may not have enough control over the unregulated or unmanaged traffic that contends with the low-latency traffic within the infrastructure basic service set (BSS). In some embodiments, the infrastructure BSS is a basic service set that includes an AP and one or more non-APs, while independent BSS is a basic service set where stations communicate with each other without the need for a centralized AP. Some of the unregulated or unmanaged traffic that interferes with the latency-sensitive traffic in the AP's BSS may originate from uplink, downlink, or direct link communications within the infrastructure BSS that the AP manages. Another source of the interference may be transmission from the neighboring infrastructure OBSS (Overlapping Basic Service Set), while others may come from neighboring independent BSS or P2P networks. Therefore, the next generation WLAN system needs mechanisms to more effectively handle unmanaged traffic while prioritizing low-latency traffic in the network. On the other hand, a P2P communication device (or P2P device) may also suffer from interference caused by the infrastructure BSS. The P2P device may or may not be associated with the infrastructure AP as shown in FIG. 4.

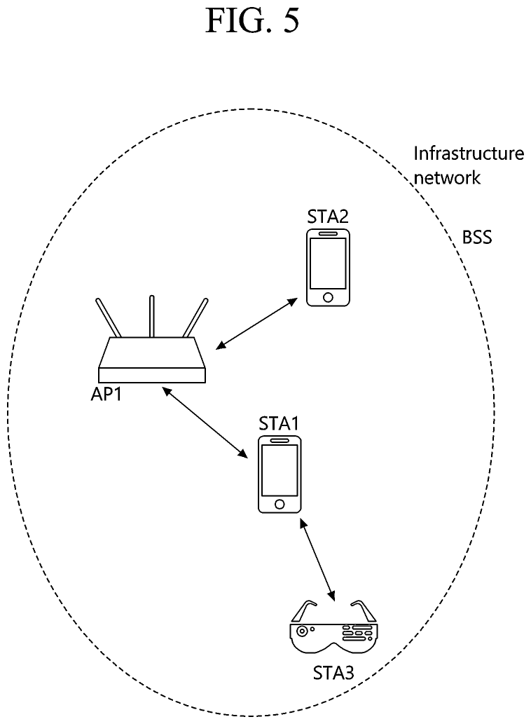

FIG. 5 shows an example of a P2P link and infrastructure network in accordance with an embodiment.

Referring to FIG. 5, AP 1 forms an infrastructure BSS. STA 1 and STA 2 are associated with AP 1, and STA 3 is a peer STA that communicates with STA 1 in a P2P link. STA 3 is not associated with AP 1. AP 1 is an infrastructure AP. In this example, STA 3 may suffer from interference from the infrastructure BSS.

When STA 3 suffers from interference originating from the infrastructure BSS, it may cause degradation in performance for the P2P communication between STA 1 and STA 3. Therefore, AP 1 may have to take measures to reduce the interference towards STA 3, which may be referred to as the victim P2P STA or victim STA. Therefore, a mechanism is needed to reduce the interference from the infrastructure network toward the victim P2P STA. However, the current WLAN system does not provide such mechanisms.

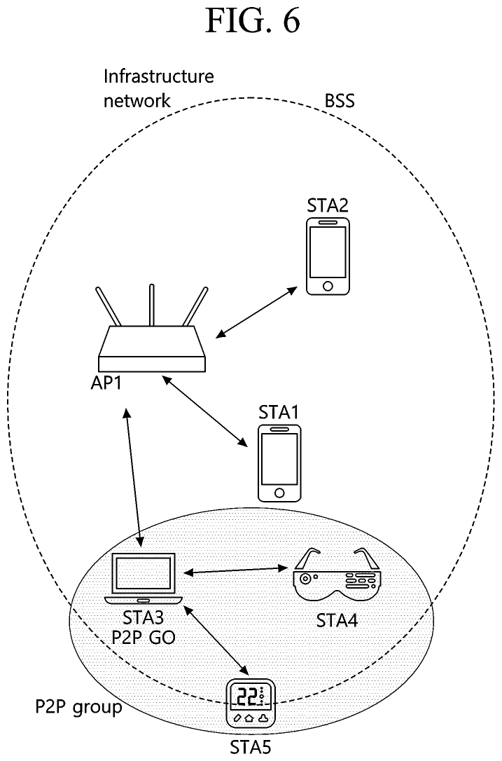

FIG. 6 shows another example of a P2P link and infrastructure network in accordance with an embodiment.

Referring to FIG. 6, AP 1 forms an infrastructure BSS. STA 1, STA 2, and STA 3 are associated with AP 1. STA 4 and STA 5 are peer STAs that communicate with STA 3. STA 3 is a group owner (GO) for a P2P group. STA 4 and STA 5 are members of the P2P group but are not associated with AP 1. As shown in FIG. 6, STA 3 and STA 4 are located within the BSS, while STA 5 is either just outside or at the edge of the BSS.

In this example, STA 3 and STA 4 may experience interference from the infrastructure BSS. Therefore, when STA 4 (the victim P2P STA) is a member of the P2P Group, STA 3 (the P2P GO) needs to mitigate this interference, for example, by coordinating with the infrastructure AP (AP 1). However, the current WLAN system does not provide such a mechanism. Thus, there needs to be a mechanism that enables STA 3 to take actions to reduce interference from the infrastructure network.

The disclosure provides various solutions and embodiments for better coexistence between the P2P network and the infrastructure network, for example and without limitation, to minimize interference to the P2P network from the infrastructure network.

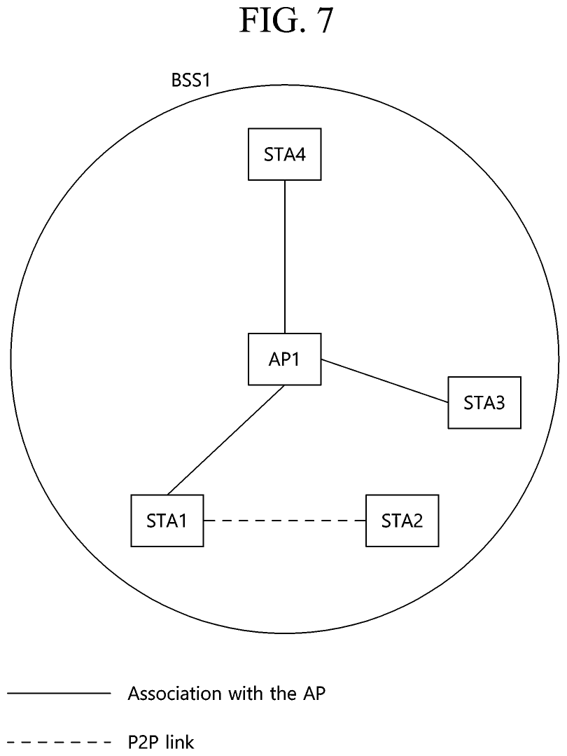

FIG. 7 shows an example scenario of a P2P network and infrastructure network in accordance with an embodiment. The operation depicted in FIG. 7 is for illustration purposes and does not limit the scope of this disclosure to any particular implementations.

Referring to FIG. 7, AP 1 forms a BSS 1 and is associated with STA 1, STA 3, and STA 4. STA 1 has set up a P2P link with STA 2 which is not associated with AP 1. In this scenario, the P2P link between STA 1 and STA 2 may experience interference caused by communications within infrastructure BSS 1. STA 1 may send a P2P assistance request to AP 1 to minimize the impact of communication in BSS 1 on the P2P link. In FIG. 7, solid lines between stations represent uplink or downlink with AP 1, while the dashed lines between stations represent a P2P link between STAs.

In some embodiments, a first STA is associated with an AP and has formed a P2P link with a second STA. When the first STA intends to seek assistance from the AP for protection of the P2P communication between the first STA and the second STA, the first STA may send a P2P assistance request frame to the AP indicating a need to protect the P2P link.

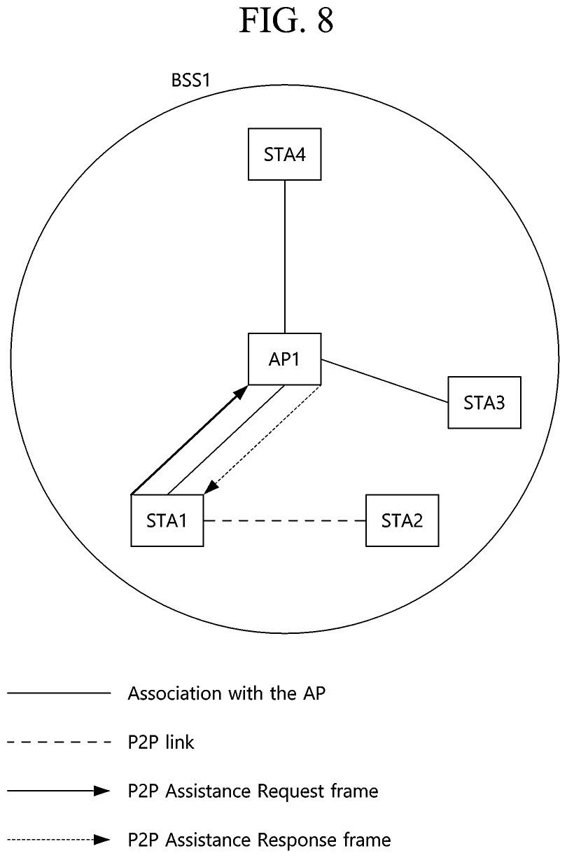

FIG. 8 shows an example P2P assistance in accordance with an embodiment. The operation depicted in FIG. 8 is for illustration purposes and does not limit the scope of this disclosure to any particular implementations.

The example of FIG. 8 is based on the scenario depicted in FIG. 7. Referring to FIG. 8, STA 1 send a P2P assistance request frame to AP 1. In response, AP 1 sends a P2P assistance response frame to STA 1. The P2P assistance request frame may carry information, for example and without limitation, including:
i) AID of STA 1;
ii) AID of STA 2;
iii) MAC Address of STA 1;
iv) MAC Address of STA 2;
v) Interference level perceived by STA 1 and/or STA 2 due to a transmission from BSS 1;
vi) Maximum interference level tolerable by the P2P link (e.g., maximum received power from the infrastructure network);
vii) An indication of whether STA 1 or/and STA 2 are the victim STAs;
viii) An identification for the P2P link;
ix) An identification (e.g. AID) of STA in BSS 1 that causes interference to the P2P link;
x) Type of assistance needed for the P2P link from BSS 1. For example, AP 1 i) lowers the transmission power (e.g., using spatial reuse procedures), or ii) perform beamforming in another direction to mitigate interference to the victim STAs; and
xi) Timeline of operation for the P2P link. For example, STA 1 shares TWT information, TDLS (tunneled direct-link setup) peer PSM (power save mode) information, TDLS U-APSD (unscheduled automatic power save delivery) information, or any other power saving mechanism adopted by victim STAs. Based on this shared information, the AP will know when to assist the P2P link, for example, by i) muting the transmission, ii) not triggering nearby infrastructure STAs for uplink, iii) performing spatial reuse for power reduction, or iv) creating a null beam towards the victim STAs.

Upon receiving the P2P assistance request frame from STA 1, AP 1 sends a P2P assistance response frame to STA 1 indicating how the AP 1 intends to assist the P2P communication between STA 1 and STA 2. The P2P assistance response frame may carry information, for example and without limitation, including:
i) An indication of whether AP 1 accepts or rejects the P2P assistance request;
ii) An indication of types of assistance that will be provided by AP 1. For example, i) reducing power level, ii) performing beamforming, or iii) not scheduling transmission during the P2P link operation;
iii) AID of STA 1;
iv) AID of STA 2;
v) MAC Address of STA 1;
vi) MAC Address of STA 2;
vii) An identification for the P2P link;
viii) Alternative suggestion for the timeline for the P2P link operation; and
ix) Alternative suggestion for other P2P parameters to use by STA 1 and STA 2. For example, AP 1 may recommend increasing or decreasing the P2P transmission power with indication of the maximum transmission power that the P2P STAs should use.

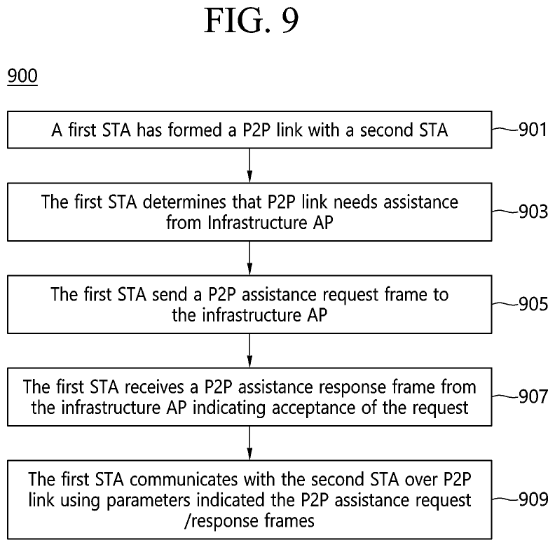

FIG. 9 shows an example process 900 of coexistence between the P2P network and the infrastructure network in accordance with an embodiment. For explanatory and illustration purposes, the process 900 may be performed by STA 1 depicted in FIG. 8. Although one or more operations are described or shown in particular sequential order, in other embodiments the operations may be rearranged in a different order, which may include performance of multiple operations in at least partially overlapping time periods.

Referring to FIG. 9, the process 900 may begin in operation 901. In operation 901, a first STA has formed a P2P link with a second STA. The first STA is associated with an infrastructure AP in its BSS, while the second STA is not associated with the infrastructure AP.

In operation 903, the first STA may experience interference from the infrastructure BSS formed by the AP. The first STA determines that the P2P link needs assistance from the infrastructure AP to protect the P2P link. In some embodiments, the assistance may be associated with providing better channel access opportunity or reducing the perceived interference level for the P2P link.

In operation 905, the first STA sends a P2P assistance request frame to the infrastructure AP. The P2P assistance request frame may include various parameters indicating requests for assistance from the infrastructure AP.

In operation 907, the first STA receives a P2P assistance response frame from the infrastructure AP that indicates the acceptance to the request for assistance. The P2P assistance response frame may include various parameters indicating acceptance of the request for assistance from the infrastructure AP. In some embodiments, the response may be associated with providing better channel access opportunity or reducing the interference level from the infrastructure BSS.

In operation 909, the first STA initiates communication with the second STA over the P2P link using parameters indicated in the P2P assistance request frame or the P2P assistance response frame.

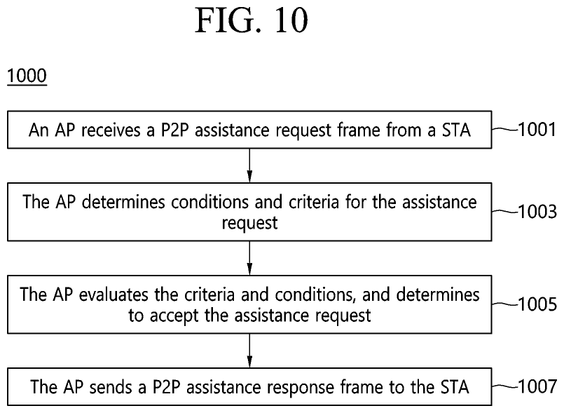

FIG. 10 shows another example process 1000 of coexistence between the P2P network and the infrastructure network in accordance with an embodiment. For explanatory and illustration purposes, the process 1000 may be performed by AP 1 depicted in FIG. 8. Although one or more operations are described or shown in particular sequential order, in other embodiments the operations may be rearranged in a different order, which may include performance of multiple operations in at least partially overlapping time periods.

Referring to FIG. 10, the process 1000 may begin in operation 1001. In operation 1001, an AP receives a P2P assistance request frame from a STA. The AP is an infrastructure AP that forms its infrastructure BSS, and the STA forms a P2P link with another STA. The STA is associated with the AP, while another STA is not associated with the AP. The P2P assistance request frame may be associated with providing better channel access opportunity or reducing the perceived interference level for the P2P link to reduce interference from the infrastructure BSS to the P2P link.

In operation 1003, upon receiving the P2P assistance request frame, the AP determines conditions and criteria for the assistance request.

In operation 1005, the AP evaluates the criteria and conditions for the requested assistance. Then, the AP determines to accept the requested assistance from the STA.

In operation 1007, the AP sends a P2P assistance response frame to the STA. The P2P assistance response frame may include various parameters indicating acceptance of the requested assistance.

In some embodiments, the STA that sends the P2P assistance request frame to the AP may or may not be associated with the AP.

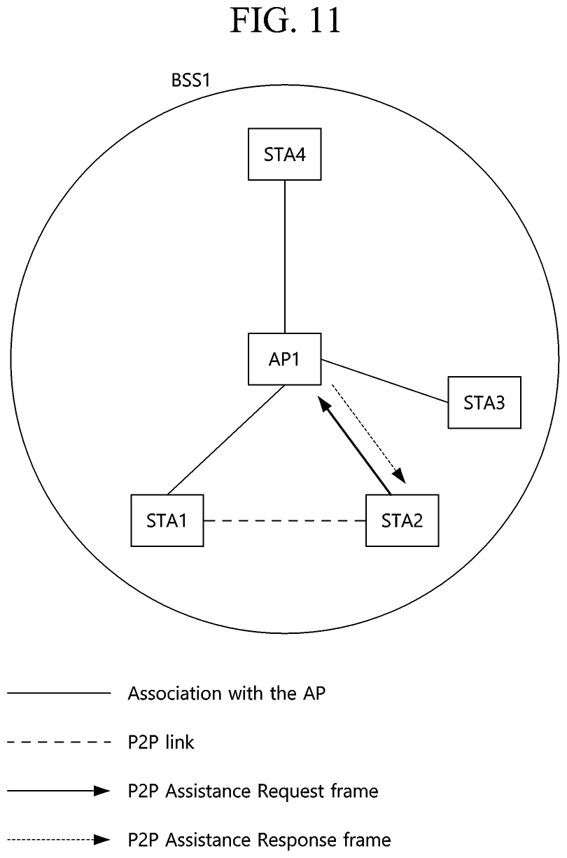

FIG. 11 shows another example of coexistence between the P2P network and the infrastructure network in accordance with an embodiment. The operation depicted in FIG. 11 is for illustration purposes and does not limit the scope of this disclosure to any particular implementations.

The example of FIG. 11 is also based on the scenario depicted in FIG. 7. Referring to FIG. 11, STA 2 is not associated with AP 1, which is unlike the example of FIG. 8. STA 2 sends a P2P assistance request frame to AP 1. In response, AP 1 sends a P2P assistance response frame to STA 2. Then, STA 2 communicates with STA 1 with the assistance from AP 1.

In some embodiments, when a STA is a P2P GO of a P2P group, the STA may send a P2P assistance request frame to an AP to request assistance to protect the P2P communication in the P2P group. The STA may be associated with the AP. In an embodiment, the STA may not be associated with the AP.

In some embodiments, a P2P GO may send a P2P group assistance request frame to an infrastructure AP, for example and without limitation, indicating i) a request for resource (e.g., time, frequency, and channel access opportunity), ii) a request to reduce interference toward P2P group to ensure better P2P communication within the P2P group (e.g., reduction of transmission power from infrastructure BSS to P2P group), and/or iii) a request to create a null beam toward the P2P group.

In some embodiments, the P2P group assistance request frame may include request information, for example and without limitation, including:
i) AIDs or a subset of the AIDs of STAs in the P2P group that need the assistance;
ii) MAC address or a subset of the MAC addresses of STAs in the P2P group that need the assistance;
iii) Interference level perceived by STAs in the P2P group;
iv) Maximum interference level tolerable by the P2P link (e.g., maximum received power from the infrastructure network);
v) A list of subsets of the STAs in the P2P group that need assistance;
vi) Identification of P2P links in the P2P group;
vii) Identifications (e.g., AID) of the STAs in infrastructure BSS causing interference toward the P2P links in the P2P group;
viii) Types of assistance needed for the P2P group from the infrastructure BSS. For example, whether the requesting P2P STA group needs the AP (or any STAs associated with the AP) to lower its transmission power or perform beamforming in another direction to avoid or mitigate interference for the victim STAs; and
ix) Timeline of operation for the P2P links in the P2P. For example, the requesting P2P STA may share TWT information, TDLS peer PSM information, TDLS U-APSD information, or any other power saving mechanism adopted by the P2P STAs in the P2P. By knowing this information, the AP will know when to assist the P2P link by i) muting the AP's transmission, ii) not triggering nearby infrastructure STAs for uplink, iii) perform spatial reuse, or iv) creating a null beam towards the victim STAs.

In some embodiments, upon receiving the P2P group assistance request frame from a P2P STA (e.g., P2P GO) for P2P assistance for the P2P group, the AP may send a P2P group assistance response frame to the P2P STA indicating how the AP intends to assist the P2P communication between P2P STAs in the P2P group. The P2P group assistance response frame may include response information, for example and without limitation, including:
i) An indication of whether the AP accepts or rejects the P2P group assistance request;
ii) An indication of types of assistance provided by the AP. For example, reduction of power level, beamforming, and stopping scheduling transmission during the P2P link operation;
iii) AIDs of a subset of STA within the P2P group that can be benefited by the AP's assistance;
iv) MAC addresses of a subset of STA within the P2P group that can be benefited by the AP's assistance;
v) An identification for the P2P links within the P2P group for which the P2P assistance is provided;
vi) Alternative suggestion for the timeline for the P2P link operation within the P2P group. For example, an alternative TWT information or TDLS peer PSM; and
vii) Alternative suggestion for other P2P parameters for P2P STAs. For example, i) a recommendation of increasing or decreasing the P2P transmission power within the P2P group, iii) indication of the maximum transmission power that the P2P STAs should use, or iv) number of MCS to use for the P2P group.

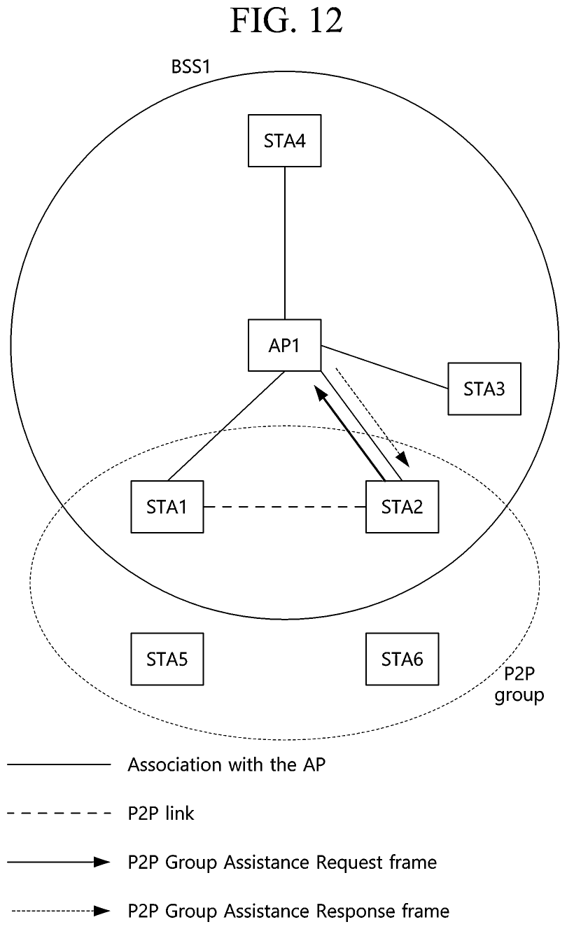

FIG. 12 shows another example of coexistence between the P2P network and the infrastructure network in accordance with an embodiment. The operation depicted in FIG. 12 is for illustration purposes and does not limit the scope of this disclosure to any particular implementations.

Referring to FIG. 12, AP 1 forms BSS 1 and is associated with STA 2, STA 3, and STA 4. STA 2 is a member of a P2P group that includes STA 1, STA 2, STA 5, and STA 6. STA 1 and STA 2 communicate over a P2P link established between them. Also, STA 5 and STA 6 are out of BSS 1. In this scenario, STA 2 may be a P2P GO of the P2P group. When the P2P group experience interference from the BSS 1, the STA 2 (P2P GO) may send a P2P group assistance request frame to the AP 1 indicating a request for assistance to protect communication in the P2P group. In response, AP 1 sends a P2P group assistance response from the STA 2 indicating the acceptance of the request or assistance which is provided by BSS 1.

Various embodiments described in this disclosure provide a mechanism for coexistence between P2P networks and infrastructure networks. By coordinating with the infrastructure BSS, the P2P network can reduce interference from the infrastructure BSS. This coordination helps to protect and enhance P2P communication.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) in a wireless network, comprising:
a memory; and
a processor coupled to the memory, the processor configured to cause:
establishing a peer-to-peer (P2P) link with a second STA;
transmitting, to an access point (AP), a first frame that requests the AP to assist in protecting a P2P communication between the first STA and the second STA;
receiving, from the AP, a second frame that indicates assistance that the AP is able to provide in response to the first frame; and
communicating with the second STA based on the assistance provided from the AP.

2. The first STA of claim 1, wherein the assistance is associated with reduction of interference to the P2P link from a basic service set (BSS) corresponding to the AP.

3. The first STA of claim 1, wherein the assistance is associated with channel access opportunity by the first STA or the second STA.

4. The first STA of claim 1, wherein the first STA is associated with the AP and the second STA is not associated with the AP.

5. The first STA of claim 1, wherein the first STA is not associated with the AP and the second STA is associated with the AP.

6. The first STA of claim 1, wherein the first STA is an owner of a P2P group that includes the first STA and the second STA.

7. The first STA of claim 2, wherein at least one of the first STA or the second STA is within the BSS.

8. An access point (AP) in a wireless network, comprising:
a memory; and
a processor coupled to the memory, the processor configured to cause:
receiving, from a first STA, a first frame that requests the AP to assist in protecting a peer-to-peer (P2P) communication with a second STA over a P2P link established between the first STA and the second STA;
determining assistance to provide the first STA based on the first frame; and
transmitting, to the first STA, a second frame that indicates the assistance that the AP is able to provide.

9. The AP of claim 8, wherein the assistance is associated with reduction of interference to the P2P link from a basic service set (BSS) corresponding to the AP.

10. The AP of claim 8, wherein the assistance is associated with channel access opportunity by the first STA or the second STA.

11. The AP of claim 8, wherein the first STA is associated with the AP and the second STA is not associated with the AP.

12. The AP of claim 8, wherein the first STA is not associated with the AP and the second STA is associated with the AP.

13. The AP of claim 8, wherein the first STA is an owner of a P2P group that includes the first STA and the second STA.

14. The AP of claim 9, wherein at least one of the first STA or the second STA is within the BSS.

15. A method performed by a first station (STA) in a wireless network, comprising:
establishing a peer-to-peer (P2P) link with a second STA;
transmitting, to an access point (AP), a first frame that requests the AP to assist in protecting a P2P communication between the first STA and the second STA;
receiving, from the AP, a second frame that indicates assistance that the AP is able to provide in response to the first frame; and
communicating with the second STA based on the assistance provided from the AP.

16. The method of claim 15, wherein the assistance is associated with reduction of interference to the P2P link from a basic service set (BSS) of the AP.

17. The method of claim 15, wherein the assistance is associated with channel access opportunity by the first STA or the second STA.

18. The method of claim 15, wherein the first STA is associated with the AP and the second STA is not associated with the AP.

19. The method of claim 15, wherein the first STA is not associated with the AP and the second STA is associated with the AP.

20. The method of claim 15, wherein the first STA is an owner of a P2P group that includes the first STA and the second STA.
